(19) United States
(12) Patent Application Publication
(10) Pub. No.: US 2006/0210111 A1
(43) Pub. Date: Sep. 21, 2006

(54) Systems and methods for eye-operated three-dimensional object location

(76) Inventors: Dixon Cleveland, Annandale, VA (US); Arthur W. Joyce III, Vienna, VA (US)

Correspondence Address: ATTN: Shari Oley;LC Technologies Inc., Suite 120, 3955 Pender Drive, Fairfax, VA, 22030, US

(21) Appl. No.: 11/375,038

(22) Filed: Mar. 15, 2006

Related U.S. Application Data
(60) Provisional application No. 60/661,962, filed on Mar. 16, 2005.

(51) Int. Cl. G01C 3/14; H04N 13/00; G06K 9/00

(52) U.S. Cl. 382/103; 382/154; 382/117; 348/42; 356/12

(57) ABSTRACT

In an embodiment of the invention, a stereoscopic image of an object is obtained using two cameras. The locations and orientations of the two cameras are obtained. The stereoscopic image of the object is displayed on a stereoscopic display. A first gaze line from a right eye and a second gaze line from a left eye of an observer viewing the object on the stereoscopic display are measured. A location of the object in the stereoscopic image is calculated from an intersection of the first gaze line and the second gaze line. The three-dimensional location of an object is calculated from the locations and orientations of the two cameras and the location of the object in the stereoscopic image.

This application claims the benefit of U.S. Provisional Application No. 60/661,962, filed Mar. 16, 2005, which is herein incorporated by reference in its entirety.

### BACKGROUND

1. Field of the Invention

Embodiments of the present invention relate to systems and methods for determining the three-dimensional location of an object using a remote display system. More particularly, embodiments of the present invention relate to systems and methods for determining the binocular fixation point of a person's eyes while viewing a stereoscopic display and using this information to calculate the three-dimensional location of an object shown in the display.

2. Background of the Invention

It is well known that animals (including humans) use binocular vision to determine the three-dimensional (3-D) locations of objects within their environments. Loosely speaking, two of the object coordinates, the horizontal and vertical positions, are determined from the orientation of the head, the orientation of the eyes within the head, and the position of the object within the eyes' two-dimensional (2-D) images. The third coordinate, the range, is determined using stereopsis: viewing the scene from two different locations allows the inference of range by triangulation.

Though humans implicitly use 3-D object location information to guide the execution of their own physical activities, they have no natural means for exporting this information to the outside world. As a result, a key limitation of almost all current remote display systems is that the presentation is only two-dimensional and the observer cannot see in the third dimension. 3-D information is critical for determining the range to an object.

In view of the foregoing, it can be appreciated that a substantial need exists for systems and methods that can advantageously provide 3-D object location information based on an operator simply looking at an object in a remote display.

### BRIEF SUMMARY OF THE INVENTION

One embodiment of the present invention is a system for determining a 3-D location of an object. This system includes a stereoscopic display, a gaze tracking system, and a processor. The stereoscopic display displays a stereoscopic image of the object. The gaze tracking system measures a first gaze line from a right eye and a second gaze line from a left eye of an observer viewing the object on the stereoscopic display. The processor calculates a location of the object in the stereoscopic image from an intersection of the first gaze line and the second gaze line.

Another embodiment of the present invention is a system for determining a 3-D location of an object that additionally includes two cameras. The two cameras produce the stereoscopic image and the processor further calculates the 3-D location of the object from the locations and orientations of the two cameras and the location of the object in the stereoscopic image.

Another embodiment of the present invention is a method for determining a 3-D location of an object. A stereoscopic image of the object is obtained using two cameras. Locations and orientations of the two cameras are obtained. The stereoscopic image of the object is displayed on a stereoscopic display. A first gaze line from a right eye and a second gaze line from a left eye of an observer viewing the object on the stereoscopic display are measured. A location of the object in the stereoscopic image is calculated from an intersection of the first gaze line and the second gaze line. The 3-D location of the object is calculated from the locations and orientations of the two cameras and the location of the object in the stereoscopic image.

### BRIEF DESCRIPTION OF THE DRAWINGS

FIG. 1 is a schematic diagram of an exemplary 3-D object location system, in accordance with an embodiment of the present invention.

FIG. 2 is a schematic diagram of exemplary remote sensors of a 3-D object location system used to view targets in real space, in accordance with an embodiment of the present invention.

FIG. 3 is a schematic diagram of an exemplary stereoscopic viewer of a 3-D object location system used to stereoscopically display a 3-D image to an observer in 3-D image space, in accordance with an embodiment of the present invention.

FIG. 4 is a schematic diagram of an exemplary binocular gaze eyetracker of a 3-D object location system used to observe a binocular gaze of an observer viewing a stereoscopic 3-D image, in accordance with an embodiment of the present invention.

FIG. 5 is a flowchart showing an exemplary method for determining a 3-D location of an object, in accordance with an embodiment of the present invention.

### DETAILED DESCRIPTION OF THE INVENTION

It has long been known that the angular orientation of the optical axis of the eye can be measured remotely by the corneal reflection method. The method takes advantage of the eye's properties that the cornea is approximately spherical over about a 35 to 45 degree cone around the eye's optic axis, and the relative locations of the pupil and a reflection of light from the cornea change in proportion to eye rotation. The corneal reflection method for determining the orientation of the eye is described in U.S. Pat. No. 3,864,030, for example, which is incorporated by reference herein.

Generally, systems used to measure angular orientation of the optical axis of the eye by the corneal reflection method include a camera to observe the eye, a light source to illuminate the eye, and a processor to perform image processing and mathematical computations. An exemplary system employing the corneal reflection method is described in U.S. Pat. No. 5,231,674 (hereinafter the “'674 patent”), which is incorporated by reference herein. A system employing the corneal reflection method is often referred to as a gaze tracking system. Embodiments of the present invention incorporate components of a gaze tracking system in order to determine a binocular fixation or gaze point of an observer and to use this gaze point to calculate the 3-D location of a remote object.

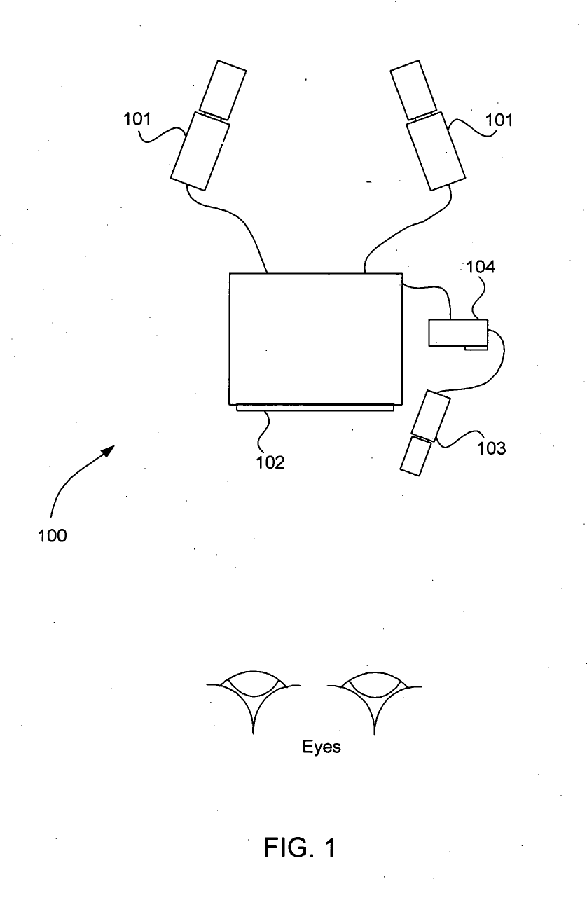

FIG. 1 is a schematic diagram of an exemplary 3-D object location system 100, in accordance with an embodiment of the present invention. System 100 extracts quantitative, 3-D object-location information from a person based on the observable behavior of his eyes. System 100 determines the 3-D location of an object simply by observing the person looking at the object. System 100 includes remote sensors 101, 3-D display 102, binocular gaze tracking system 103, and processor 104. Remote sensors 101 can be but are not limited to at least two video cameras. (Note: A stereo camera specifically designed to capture stereo images is generally referred to as “a” camera. In practice, however, a stereo camera actually consists of two cameras, or at least two lens systems, and provide images from 2 or more points of view. For purposes of this discussion, a stereo camera is considered two cameras.) 3-D display 102 can be but is not limited to a stereoscopic viewer that generates a true stereoscopic image based on the input from remote sensors 101. A stereoscopic viewer includes but is not limited to virtual reality glasses. Binocular gaze tracking system 103 can be but is not limited to a video camera gaze tracking system that tracks both eyes of an observer. Binocular gaze tracking system 103 can include but is not limited to the components described in the gaze tracking system of the '674 patent.

Remote sensors 101 provide the observer with a continuous, real-time display of the observed volume. Remote sensors 101 view target 201 and target 202 in real space 200, for example.

The location of remote sensors 101 and the convergence of the observed binocular gaze obtained from binocular gaze tracking system 103 provide the information necessary to locate an observed object within the real observed space. As an observer scans 3-D display 102, the 3-D location of the user's equivalent gazepoint within the real scene is computed quantitatively, automatically and continuously using processor 104. Processor 104 can be but is not limited to the processor described in the gaze tracking system of the '674 patent.

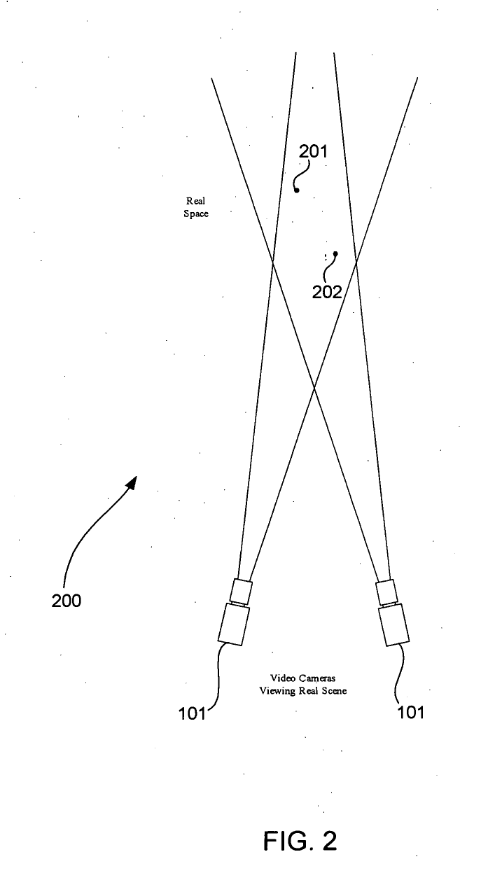

FIG. 2 is a schematic diagram of exemplary remote sensors 101 of a 3-D object location system 100 (not shown) used to view targets in real space 200, in accordance with an embodiment of the present invention. Remote sensors 101 can be, but are not limited to, at least two video cameras. Remote sensors 101 are configured to view a common volume of space from two different locations. Remote sensors 101 are preferably fixed in space. Remote sensors 101 may be either fixed or variable in space. The processor 104 (shown in FIG. 1) knows the relative locations of the two cameras with respect to each other at any given time. Thus the processor has a camera frame of reference and can compute object locations within that camera frame, i.e. with respect to the cameras.

In another embodiment of the present invention, processor 104 further knows the locations of the cameras with respect to the coordinates of the real space being observed. This real space is commonly referred to as a “world frame” of reference. In this embodiment, the processor can compute object locations within the world frame as well as within the camera frame. For example, the world frame might be the earth coordinate system, where position coordinates are defined by latitude, longitude, and altitude, and orientation parameters are defined by azimuth, elevation and bank angles. Given that the 3-D location system has determined the location of an object within its camera frame, and given that it knows the position and orientation of the camera frame with respect to the world frame, it may also compute the object location within the earth frame.

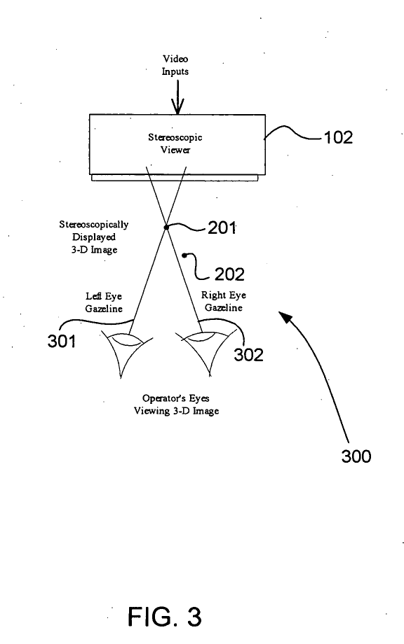

FIG. 3 is a schematic diagram of an exemplary stereoscopic viewer 102 of a 3-D object location system 100 (not shown) used to stereoscopically display a 3-D image to an observer in 3-D image space 300, in accordance with an embodiment of the present invention. Stereoscopic viewer 102 converts the video signals of remote sensors 101 (shown in FIG. 2) into a scaled 3-dimensional image of the real scene. Stereoscopic viewer 102 converts the images of target 201 and target 202 to the operator's virtual view of real space or 3-D image space 300.

An operator views 3-D image space 300 produced by stereoscopic viewer 102 with both eyes. If the operator fixates on target 201, for example, gaze line 301 of the left eye and gaze line 302 of the right eye converge at target 201.

The left- and right-eye displays of stereoscopic viewer 102 are scaled, rotated, keystoned, and offset correctly to project a coherent, geometrically correct stereoscopic image to the operator's eyes. Errors in these projections cause distorted and blurred images and result in rapid user fatigue. The mathematical synthesis of a coherent 3-D display depends on both a) the positions and orientations of the cameras within the real environment and b) the positions of the operator's eyes within the imager's frame of reference.

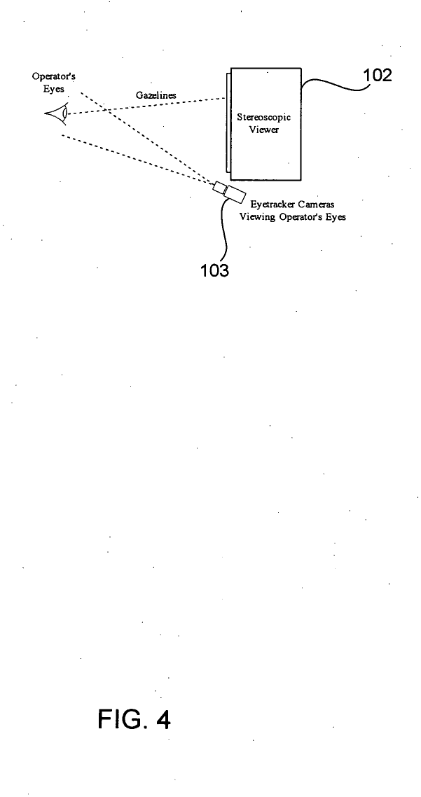

FIG. 4 is a schematic diagram of an exemplary binocular gaze tracking system 103 of a 3-D object location system 100 (not shown) used to observe a binocular gaze of an observer viewing a stereoscopic 3-D image, in accordance with an embodiment of the present invention.

Binocular gaze tracking system 103 monitors both of the operator's eyes as he views the 3-D or stereographic viewer 102. Binocular gaze tracking system 103 computes the convergence of two gaze vectors within the 3-D image space. The intersection of the two gaze vectors is the user's 3-D gaze point (target 201 in FIG. 3) within the image space. Based on the known locations and orientations of remote sensors 101 (shown in FIG. 1), a 3-D gaze point within the image scene is mathematically transformed to an equivalent 3-D location in real space.

In another embodiment of the present invention, binocular gaze tracking system 103 is a binocular gaze tracker mounted under a stereoscopic viewer to monitor the operator's eyes. The binocular gaze tracker continuously measures the 3-D locations of the two eyes with respect to the stereoscopic viewer, and the gaze vectors of the two eyes within the displayed 3-D image space.

A 3-D location is a “point of interest,” since the observer has chosen to look at it. Points of interest can include but are not limited to the location of an enemy vehicle, the target location for a weapons system, the location of an organ tumor or injury in surgery, the location of a lost hiker, and the location of a forest fire.

Due to the fixed distance between his eyes (approximately 2-3 inches), two key limitations arise in a human's ability to measure range. At long ranges beyond about 20 feet, the gaze lines of both eyes become virtually parallel, and triangulation methods become inaccurate. Animals, including humans, infer longer range from other environmental context queues, such as relative size and relative motion. Conversely, at short ranges below about six inches, it is difficult for the eyes to converge.

Embodiments of the present invention are not limited to the human stereopsis range since the distance between the sensors is not limited to the distance between the operator's eyes. Increasing the sensor separation allows stereopsis measurement at greater distances and conversely, decreasing the sensor separation allows measurement of smaller distances. The tradeoff is accuracy in the measurement of the object location. Any binocular convergence error is multiplied by the distance between the sensors. Similarly, very closely separated sensors can amplify the depth information. Any convergence error is divided by the distance between the sensors. In aerial targeting applications, for example, long ranges can be measured by placing the remote sensors on different flight vehicles, or satellite images taken at different times. The vehicles are separated as needed to provide accurate range information. In small-scale applications, such as surgery, miniature cameras mounted close to the surgical instrument allows accurate 3-D manipulation of the instrument within small spaces.

In addition to external inputs, such as a switch or voice commands, a point of interest can be designated by the operator fixing his gaze on a point for a period of time. Velocities, directions, and accelerations of moving objects can be measured when the operator keeps his gaze fixed on an object as it moves.

In another embodiment of the present invention, a numerical and graphical display shows the gaze-point coordinates in real time as the operator looks around the scene. This allows others to observe the operator's calculated points of interest as the operator looks around.

In another embodiment of the present invention, inputs from the user indicate the significance of the point of interest. A user can designate an object of interest by activating a manual switch when he is looking at the object. For example, one button can indicate an enemy location while a second button can indicate friendly locations. Additionally, the user may designate an object verbally, by speaking a key word or sound when he is looking at the object.

In another embodiment of the present invention the operator controls the movement of the viewed scene allowing him to view the scene from a point of view that he selects. The viewing perspective displayed in the stereoscopic display system may be moved either by moving or rotating the remote cameras with respect to the real scene, or by controlling the scale and/or offset of the stereoscopic display.

The user may control the scene display in multiple ways. He may, for example, control the scene display manually with a joystick. Using a joystick the operator can drive around the viewed scene manually.

In another embodiment of the present invention an operator controls the movement of the viewed scene using voice commands. Using voice commands the operator can drive around the viewed scene by speaking key words, for example, to steer the remote cameras right, left, up or down, or to zoom the lenses in or out.

In another embodiment of the present invention a 3-D object location system moves the viewed scene automatically by using existing knowledge of the operator's gazepoint. For example, the 3-D object location system automatically moves the viewed scene so that the object an operator is looking at gradually shifts toward the center of the scene.

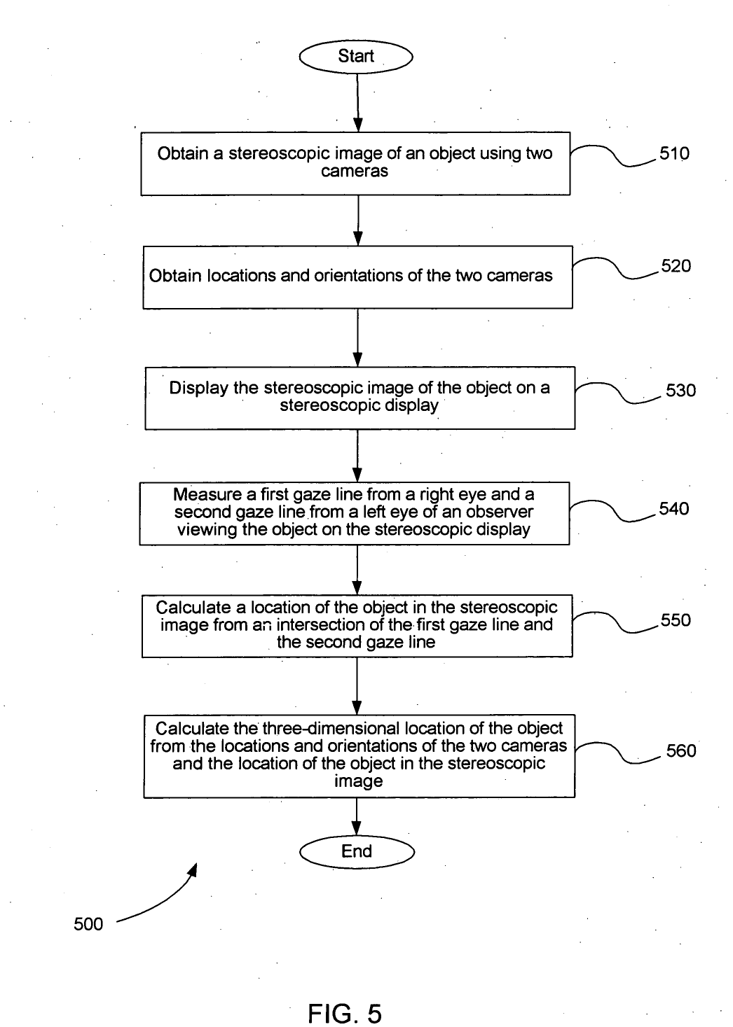

FIG. 5 is a flowchart showing an exemplary method 500 for determining a 3-D location of an object, in accordance with an embodiment of the present invention.

In step 510 of method 500, a stereoscopic image of an object is obtained using two cameras.

In step 520, locations and orientations of the two cameras are obtained.

In step 530, the stereoscopic image of the object is displayed on a stereoscopic display.

In step 540, a first gaze line from a right eye and a second gaze line from a left eye of an observer viewing the object on the stereoscopic display are measured.

In step 550, a location of the object in the stereoscopic image is calculated from an intersection of the first gaze line and the second gaze line.

In step 560, the 3-D location of the object is calculated from the locations and orientations of the two cameras and the location of the object in the stereoscopic image.

Further examples of the present invention include the following:

A first example is a method for 3-D object location, comprising a means of measuring the gaze direction of both eyes, a means of producing a stereoscopic display, and a means of determining the intersection of the gaze vectors.

A second example is a method for 3-D object location that is substantially similar to the first example and further comprises a pair of sensors, a means of measuring the orientation of the sensors, a means of calculating a point of interest based on the gaze convergence point.

A third example is a method for 3-D object location that is substantially similar to the second example and further comprises sensors that are video cameras, sensors that are still cameras, or means of measuring sensor orientation.

A fourth example is a method for 3-D object location that is substantially similar to the third example and further comprises a means for converting the intersection of the gaze vectors into coordinates with respect to the sensors.

A fifth example is a method for controlling the orientation of the remote sensors and comprises a means for translating a users point of interest into sensor controls.

A sixth example is a method for controlling the orientation of the remote sensors that is substantially similar to the fifth example and further comprises an external input to activate and/or deactivate said control.

A seventh example is a method for controlling the orientation of the remote sensors that is substantially similar to the sixth example and further comprises an external input that is a voice command.

An eighth example is a method or apparatus for determining the 3-D location of an object and comprises a stereoscopic display, a means for measuring the gaze lines of both eyes of a person observing the display, and a means for calculating the person's 3-D gazepoint within the stereoscopic display based on the intersection of the gaze lines.

A ninth example is a method or apparatus for determining the 3-D location of an object that is substantially similar to the eighth example and further comprises a pair of cameras that observe a real scene and provide the inputs to the stereoscopic display, a means for measuring the relative locations and orientations of the two cameras with respect to a common-camera frame of reference, and a means for calculating the equivalent 3-D gazepoint location within the common-camera frame that corresponds to the user's true 3-D gazepoint within the stereoscopic-display.

A tenth example is a method or apparatus for determining the 3-D location of an object that is substantially similar to the ninth example and further comprises a means for measuring the relative location and orientation of the camera's common reference frame with respect to the real scene's reference frame, and a means for calculating the equivalent 3-D gazepoint location within the real-scene frame that corresponds to the person's true 3-D gazepoint within the stereoscopic-display.

An eleventh example is a method or apparatus for determining the 3-D location of an object that is substantially similar to examples 8-10 and further comprises a means for the person to designate a specific object or location within the stereoscopic scene by activating a switch when he is looking at the object.

A twelfth example is a method or apparatus for determining the 3-D location of an object that is substantially similar to examples 8-10 and further comprises a means for the person to designate a specific object or location within the stereoscopic scene by verbalizing a key word or sound when he is looking at the object.

A thirteenth example is a method or apparatus for determining the 3-D location of an object that is substantially similar to examples 9-12 and further comprises a means for the person to control the position, orientation or zoom of the cameras observing the scene.

A fourteenth example is a method or apparatus for determining the 3-D location of an object that is substantially similar to the thirteenth example and further comprises wherein the person controls the position, orientation or zoom of the cameras via manual controls, voice command and/or direction of gaze.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A system for determining a location of an object, comprising:
a stereoscopic display, wherein the stereoscopic display displays a stereoscopic image of the object;
a gaze tracking system, wherein the gaze tracking system measures a first gaze line from a right eye and a second gaze line from a left eye of an observer viewing the object on the stereoscopic display; and
a processor, wherein the processor calculates a location of the object in the stereoscopic image from an intersection of the first gaze line and the second gaze line.

2. The system of claim 1, further comprising:
two cameras, wherein the two cameras produce the stereoscopic image, and wherein the processor calculates a three-dimensional location of the object from the locations and orientations of the two cameras and the location of the object in the stereoscopic image.

3. A method for determining a location of an object, comprising:
displaying a stereoscopic image of the object on a stereoscopic display;
measuring a first gaze line from a right eye and a second gaze line from a left eye of an observer viewing the object on the stereoscopic display; and
calculating a location of the object in the stereoscopic image from an intersection of the first gaze line and the second gaze line.

4. The method of claim 1, further comprising:
obtaining the stereoscopic image using two cameras;
obtaining locations and orientations of the two cameras; and
calculating a three-dimensional location of an object from the locations and orientations of the two cameras and the location of the object in the stereoscopic image.
